(19) United States
(12) Patent Application Publication
(10) Pub. No.: US 2015/0206622 A1
(43) Pub. Date: Jul. 23, 2015

(54) STRANDED WIRE AND GUIDEWIRE EMPLOYING THE SAME

(71) Applicant: ASAHI INTECC CO., LTD., Nagoya-shi (JP)

(72) Inventors: Satoru MURATA, Seto-shi (JP); Tadahiro KOIKE, Ama-shi (JP)

(21) Appl. No.: 14/585,987

(22) Filed: Dec. 30, 2014

(30) Foreign Application Priority Data
Jan. 20, 2014 (JP) 2014-007794

(51) Int. Cl. H01B 5/10

(52) U.S. Cl. CPC H01B 5/104

(57) ABSTRACT

A stranded wire whose deformation or breakage is suppressed so that sufficient safety is ensured, and a guidewire employing the stranded wire. The stranded wire includes a core element wire and side element wires wound so as to cover a circumference of the core element wire, the core element wire and the side element wires being stranded together. The side element wires include at least a pair of first side element wires arranged point-symmetrically around the core element wire, and a second side element wire having a tensile strength lower than a tensile strength of the core element wire and a tensile strength of the first side element wires.

### CROSS-REFERENCE TO RELATED APPLICATION

This application claims priority to Japanese Application No. 2014-007794 filed on Jan. 20, 2014, the contents of which are incorporated by reference herein in their entirety.

### BACKGROUND

The disclosed embodiments relate to a medical device. Specifically, the disclosed embodiments relate to a medical stranded wire and a guidewire employing the stranded wire.

Conventionally, various stranded wires used for a medical apparatus have been proposed for treatment or examination (such as a stent inserted into body tissue or a tubular organ, such as a blood vessel, the digestive tract, or the ureter). For example, Japanese Laid-Open Patent Publication No. 2002-105879 discloses a stranded wire (coiled body) composed of a plurality of element wires stranded together. The element wires forming this stranded wire are formed of Ni/Ti or an Ni/Ti-based alloy in order to ensure fatigue endurance for a long period of use.

### SUMMARY

In the case of, for example, a hard lesion, a lesion narrowed to a great degree, or an occluded lesion, sufficient torque transmission characteristics are required in a medical apparatus to enable insertion into the lesion. Additionally, when rotating a proximal part of an apparatus having a stranded wire during insertion of the apparatus into the above-described lesions, great torsional stress is applied to the stranded wire, whereby the stranded wire is deformed or broken and safety is compromised.

Even for the stranded wire described in the above Japanese Laid-Open Patent Publication No. 2002-105879, it is difficult to ensure sufficient safety when great torsional stress is applied to the medical apparatus during use. In this respect, there is room for improvement.

The disclosed embodiments are directed towards providing a stranded wire whose deformation or breakage is suppressed so that sufficient safety is ensured, and also towards providing a guidewire employing the stranded wire. The stranded wire and the guidewire employing the stranded wire may have the following features.

According to one aspect of the disclosed embodiments, a stranded wire may be composed of a core element wire and side element wires that are wound so as to cover a circumference of the core element wire, the core element wire and the side element wires being stranded together. The side element wires include at least a pair of first side element wires arranged point-symmetrically around the core element wire (that is, the first side element wires in a pair are disposed on opposite sides of the core element wire), and at least one second side element wire other than these first side element wires. The core element wire and the first side element wires each have a tensile strength greater than that of the second side element wire. The core element wire and the first side element wires of the stranded wire may be formed of the same material.

Additionally, the stranded wire may include a plurality of the second side element wires arranged point-symmetrically around the core element wire. The second side element wires may be formed of a radiopaque material.

The disclosed embodiments are also directed towards a guidewire including a core shaft and a coiled body covering a distal portion of the core shaft. The coiled body may be composed of a plurality of any of the stranded wires described above, wound helically.

As described above, the stranded wire may be composed of a core element wire and side element wires wound so as to cover a circumference of the core element wire, the core element wire and the side element wires being stranded together. The side element wires include at least a pair of first side element wires arranged point-symmetrically around the core element wire, and a second side element wire other than these first side element wires. Furthermore, the tensile strengths of the core element wire and the first side element wires is greater than that of the second side element wire.

Accordingly, the core element wire and the first side element wires having relatively great tensile strength are arranged linearly in a cross-sectional view of the stranded wire. These core and first side element wires are mutually energized due to their tensile strength, resulting in enhanced adhesion. That is, in the stranded wire, element wires linearly arranged adhere to one another strongly.

Consequently, it is possible to enhance torsional strength of the stranded wire. Thus, even in a case where a large torque is applied to the stranded wire and the stranded wire becomes greatly twisted, the stranded wire does not deform or break and safety is ensured.

Moreover, the tensile strength of one of side element wires in the stranded wire (the second side element wire) is relatively low. Generally, when a stranded wire is greatly twisted, torsional stress is caused in a circumferential direction, or compressive stress is caused by an outside element wire pressing an inside element wire, so that the stranded wire may be deformed or broken. However, since the element wire with relatively low tensile strength (the second side element wire) is employed for some of the side element wires in the disclosed embodiments, the second side element wire causes the above-described torsional stress to be relieved, and the inward pressing force to be reduced. As a result, deformation or breakage of the stranded wire is suppressed, and also in this respect, safety is ensured for the stranded wire.

Furthermore, the core element wire and the first side element wires may be formed of the same material. Thus, the energizing force of the core element wire and the energizing force of the first side element wires interacting with each other are equalized therebetween, so that a large torque applied to the stranded wire would seldom cause the core element wire and the first side element wires to be displaced relative to each other. Sufficient torsional strength is therefore easily ensured. Consequently, even in a case where a large torque is applied to the stranded wire and the stranded wire becomes greatly twisted, it is possible to reliably suppress deformation or breakage of the stranded wire, thereby ensuring sufficient safety.

Additionally, a plurality of the second side element wires may be provided and arranged point-symmetrically around the core element wire. Thus, torsional stress caused by a greatly twisted stranded wire is evenly relieved in a circumferential direction via the second side element wire having relatively low tensile strength. As a result, deformation or breakage of the stranded wire is effectively suppressed, and sufficient safety of the stranded wire is ensured.

The second side element wires arranged point-symmetrically around the core element wire may be formed of a radiopaque material. Accordingly, the second side element wire formed of the radiopaque material is evenly arranged in a circumferential direction of the stranded wire, thereby making it possible to ensure sufficient visibility in a radiolucent image.

The guidewire of the disclosed embodiments may be composed of a plurality of any of the stranded wires described above, wound helically. Accordingly, when pushing ahead with the guidewire along an inverted U-shaped path from the lower extremity vasculature of the right leg to the lower extremity vasculature of the left leg by, for example, the Cross-Over method, even a stranded wire that forms a coiled body and that has become greatly twisted under application of a large torque will seldom deform or break, thereby ensuring safety and making it possible to use the guidewire continuously.

### BRIEF DESCRIPTION OF THE DRAWINGS

FIG. 1 is a perspective view of a stranded wire according to the disclosed embodiments.

FIG. 2 is a cross-sectional view along A-A of the stranded wire shown in FIG. 1.

FIG. 3 is a schematic cross-sectional view of another stranded wire according to the disclosed embodiments.

FIG. 4 is a schematic cross-sectional view of yet another stranded wire according to the disclosed embodiments.

FIG. 5 is a cross-sectional view of a stranded wire according to the disclosed embodiments.

FIG. 6 is a cross-sectional view of a stranded wire according to the disclosed embodiments.

FIG. 7 is a cross-sectional view of a stranded wire according to the disclosed embodiments.

FIG. 8 is a cross-sectional view of a stranded wire according to the disclosed embodiments.

FIG. 9 is a cross-sectional view of a stranded wire according to the disclosed embodiments.

FIG. 10 is an enlarged cross-sectional view of a part of a guidewire according to the disclosed embodiments.

FIG. 11 is a cross-sectional view along B-B of a coiled body shown in FIG. 10.

### DETAILED DESCRIPTION OF EMBODIMENTS

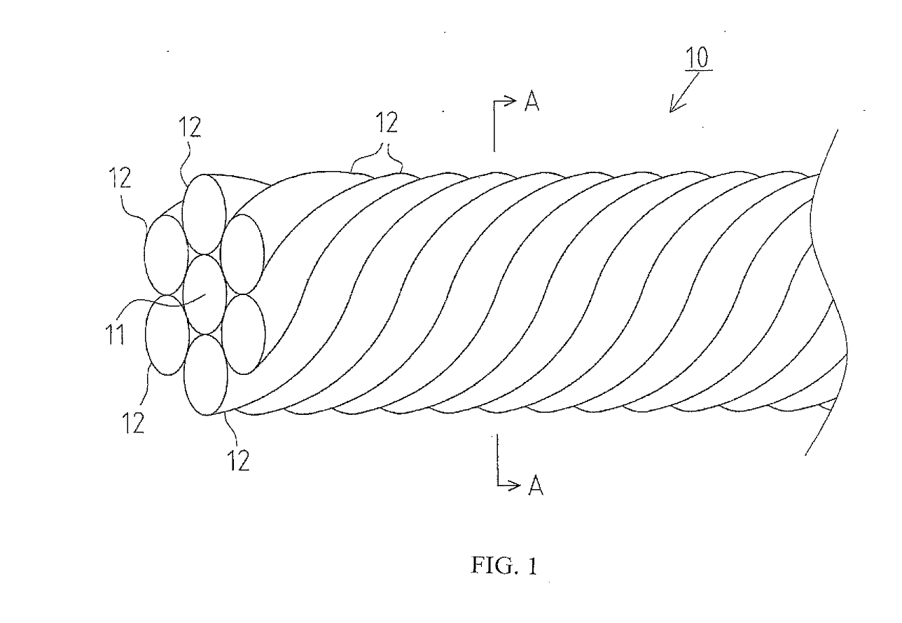

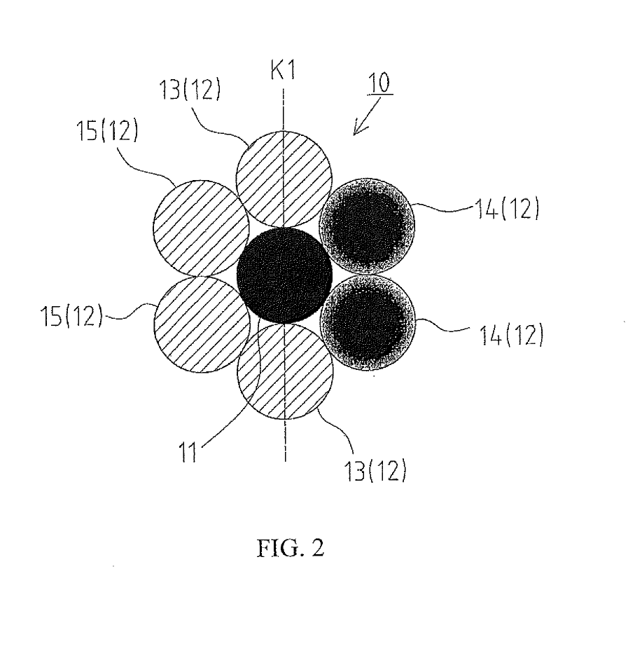

Description will be given for a stranded wire according to the disclosed embodiments with reference to FIGS. 1 and 2. It is noted that in each figure, the stranded wire is schematically illustrated at a dimensional ratio different from an actual one.

As shown in FIGS. 1 and 2, a stranded wire 10 is composed of a core element wire 11 and six side element wires 12 wound so as to cover a circumference of the core element wire 11.

As shown in FIG. 2, the side element wires 12 include a pair of first side element wires 13 arranged point-symmetrically around the core element wire 11, and four side element wires other than the first side element wires 13. In FIG. 2, the side element wires other than the first side element wires 13 include second side element wires 14 and third side element wires 15. Virtual straight line K1 passes through the center of the core element wire 11 in a vertical direction; the second side element wires 14 are located on the right of the virtual straight line K1, and the third side element wires 15 are located on the left of the virtual straight line K1.

A material forming the core element wire 11 may be different from a material forming the first side element wires 13, and the material forming the first side element wires 13 may be the same as that forming the third side element wires 15. Moreover, the second side element wires 14 may be formed of a material different from both of the above materials forming the core element wire 11 and the first side element wires 13 (as well as the third side element wires 15).

Furthermore, the tensile strength of the core element wire 11 may be greater than the tensile strength of each of the first side element wires 13 and the third side element wires 15. Additionally, the tensile strength of the second side element wires 14 may be smaller than the tensile strength of each of the core element wire 11 and the first side element wires 13. That is, the tensile strength of the element wires forming the stranded wire 10 may increase in the order of the second side element wire 14, the first side element wire 13 (and the third side element wire 15), and the core element wire 11.

For example, the tensile strength of the core element wire 11 may be 2500 to 2700 N/mm², the tensile strength of the first side element wires 13 (and the third side element wires 15) may be 2100 to 2400 N/mm², and the tensile strength of the second side element wires 14 may be 1600 to 2000 N/mm².

The materials forming the core element wire 11 and the side element wires 12 include, for example, stainless steel, platinum, tungsten, and an Ni—Ti alloy, but are not limited thereto as long as it is possible to ensure the tensile strength increased in the order of the second side element wire 14, the first side element wire 13 (and the third side element wire 15), and the core element wire 11.

For example, SUS304WPS may be employed as the material forming the core element wire 11, SUS304WPB may be employed as the material forming the first side element wires 13 (and the third side element wires 15), and SUS304-3/4H may be employed as the material forming the second side element wires 14.

As described above, the core element wire 11 and the first side element wires 13, each having relatively great tensile strength, are arranged linearly in a cross-sectional view. That is, the core element wire 11 and the first side element wires 13, each having relatively great tensile strength, are arranged along the virtual straight line K1 passing through the center of the core element wire 11 in a vertical direction.

The core element wire 11 and first side element wires 13 are mutually energized due to their tensile strength, resulting in enhanced mutual adhesion. Thus, in the stranded wire 10, the three element wires 11, 13, and 13 arranged linearly along the virtual straight line K1 adhere to one another strongly.

Consequently, it is possible to enhance torsional strength of the stranded wire 10. Even in a case where a large torque is applied to the stranded wire 10 and the stranded wire 10 becomes greatly twisted, the stranded wire 10 does not deform or break, and safety is ensured.

Moreover, the tensile strength of some of the side element wires (the second side element wires 14) may be lower compared to other element wires 11, 13, and 15. Generally, a stranded wire composed of a plurality of element wires stranded together has, when greatly twisted, torsional stress in a circumferential direction, and compressive stress caused by an outside element wire pressing an inside element wire (e.g., a core element wire), so that the stranded wire may be deformed or broken.

However, in the disclosed embodiments, since an element wire with relatively low tensile strength (the second side element wire 14) is employed for some of the side element wires, the second side element wire 14 causes the above-described torsional stress to be relieved, and the inward pressing force to be reduced. As a result, deformation or breakage of the stranded wire 10 is suppressed, and also in this respect, safety is ensured for the stranded wire 10.

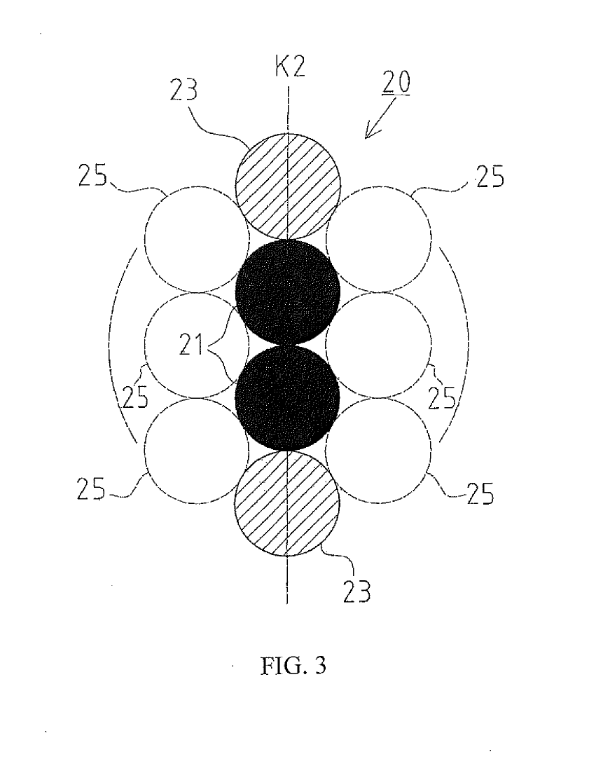

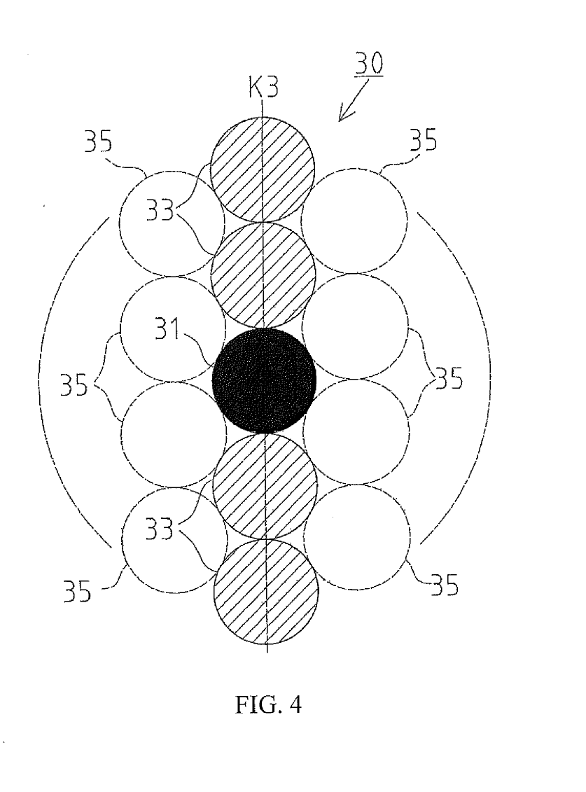

In each of the stranded wires described above, three element wires with relatively great tensile strength are arranged along a virtual straight line passing through the center of the core element wire in a vertical direction. However, the number of element wires is not limited thereto, and may be four or more (see FIGS. 3 and 4, for example).

FIG. 3 shows a stranded wire 20 having an even number (such as four or more) of element wires with relatively great tensile strength arranged along a virtual straight line K2. A pair of element wires located in the center are regarded as core element wires 21, and the other element wires are first side element wires 23. In such a conformation, at least one of side element wires 25 other than the first side element wires 23 is formed of a material with a tensile strength lower than that of the core element wires 21 and the first side element wires 23.

FIG. 4 shows a stranded wire 30 having an odd number (such as five or more) of element wires with relatively great tensile strength arranged along a virtual straight line K3. Element wires arranged in a line, other than a core element wire 31 located in the center, are first side element wires 33. That is, in this case, there are two or more pairs of the first side element wires 33 arranged along the virtual straight line K3. In such a conformation, at least one of side element wires 35 other than the first side element wires 33 is formed of a material with a tensile strength lower than that of the core element wire 31 and the first side element wires 33.

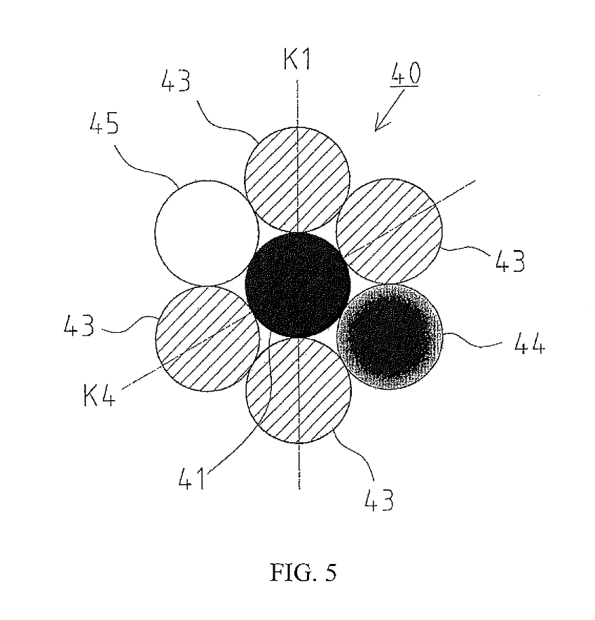

Description will be given for other variations of the stranded wire according to the disclosed embodiments with reference to FIGS. 5-9. The same components as described above have the same reference signs and will not be further described. Any differences will be mainly described below.

In the stranded wires described above, only one pair of the first side element wires is arranged point-symmetrically around the core element wire. In FIG. 5, a stranded wire 40 is provided with two pairs of first side element wires 43 arranged point-symmetrically around a core element wire 41. That is, the first side element wires 43 are arranged not only along the virtual straight line K1 but also along a virtual straight line K4 passing through the center of the core element wire 41. The element wires arranged along each of the virtual straight line K1 and the virtual straight line K4 (the core element wire 41 and the first side element wires 43) have relatively great tensile strength.

In FIG. 5, among two side element wires other than the first side element wires 43, one is a second side element wire 44, and the other is a third side element wire 45. Materials forming the core element wire 41, the first side element wires 43, the second side element wire 44, and the third side element wire 45 may be the same as those described above. That is, the tensile strength of the element wires forming the stranded wire 40 may increase in the order of the second side element wire 44, the first side element wire 43 (and the third side element wire 45), and the core element wire 41.

In a cross-sectional view of the stranded wire 40 as described above, the core element wire 41 and the first side element wires 43, each having relatively great tensile strength, are arranged along the virtual straight lines K1 and K4, respectively. The core element wire 41 and the first side element wires 43 are mutually energized due to their tensile strength, resulting in enhanced mutual adhesion. Thereby, in the stranded wire 40, the element wires 41 and 43 linearly arranged along both the virtual straight lines K1 and K4 adhere to each other strongly.

Consequently, it is possible to greatly enhance the torsional strength of the stranded wire 40, and even in a case where a large torque is applied to the stranded wire 40 and the stranded wire 40 becomes greatly twisted, safety is ensured for the stranded wire 40 without deformation or breakage.

Moreover, the tensile strength of one of the side element wires (the second side element wire 44) may be lower relative to the other element wires 41, 43, and 45. Generally, a stranded wire composed of a plurality of element wires stranded together has, when greatly twisted, torsional stress in a circumferential direction, and compressive stress caused by an outside element wire pressing an inside element wire (e.g., a core element wire), so that the stranded wire may be deformed or broken.

However, since the element wire with relatively low tensile strength (the second side element wire 44) is employed for some of the side element wires of the stranded wire 40, the second side element wire 44 causes the above-described torsional stress to be relieved, and the inward pressing force to be reduced. As a result, deformation or breakage of the stranded wire 40 is suppressed, and also in this respect, safety is ensured for the stranded wire 40.

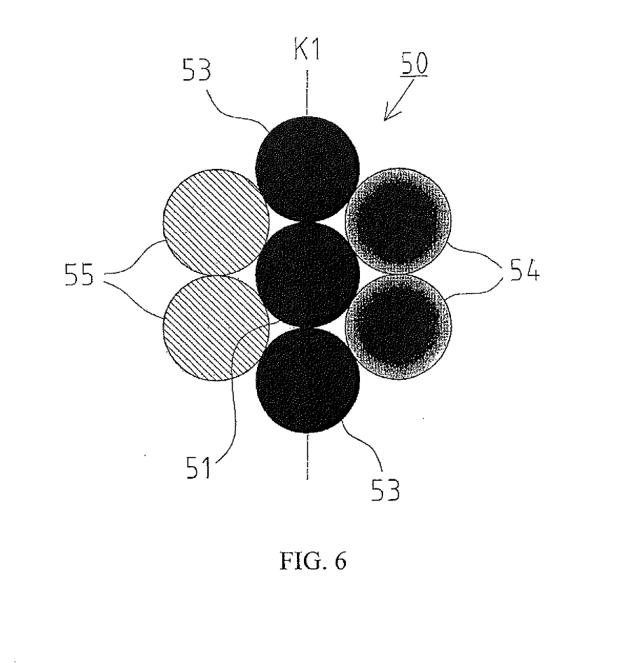

In the stranded wires described above, the material forming the core element wire is different from the material forming the first side element wire. Whereas, in a stranded wire 50 shown in FIG. 6, a core element wire 51 and first side element wires 53 are formed of the same material.

In stranded wire 50, side element wires other than the first side element wires 53 include second side element wires 54 and third side element wires 55. The virtual straight line K1 passes through the center of the core element wire 51 in a vertical direction; the second side element wires 54 are located on the right side of the virtual straight line K1, and the third side element wires 55 are located on the left side of the virtual straight line K1.

As materials, SUS304WPS may be employed as the material forming the core element wire 51 and the first side element wires 53, SUS304WPB may be employed as the material forming the third side element wires 55, and SUS304-3/4H may be employed as the material forming the second side element wires 54. Thus, the tensile strength of the element wires forming the stranded wire 50 may increase in the order of the second side element wire 54, the third side element wire 55, and the core element wire 51 (and the first side element wire 53).

Sufficient torsional strength is therefore ensured for the stranded wire 50, even in a case where a large torque is applied to the stranded wire 50 and the stranded wire 50 becomes greatly twisted. Thus, the stranded wire 50 is seldom deformed or broken, and safety is ensured.

Additionally, where the core element wire 51 and the first side element wires 53 are formed of the same material, the energizing force of the core element wire 51 and the energizing force of the first side element wires 53 interacting with each other are equalized therebetween, so that a large torque applied to the stranded wire 50 does not cause the core element wire 51 and the first side element wire 53 to be displaced relative to each other. Sufficient torsional strength is thereby easily ensured.

Consequently, even where a large torque is applied to the stranded wire 50 and the stranded wire 50 becomes greatly twisted, it is possible to reliably suppress deformation or breakage of the stranded wire 50, thereby ensuring sufficient safety.

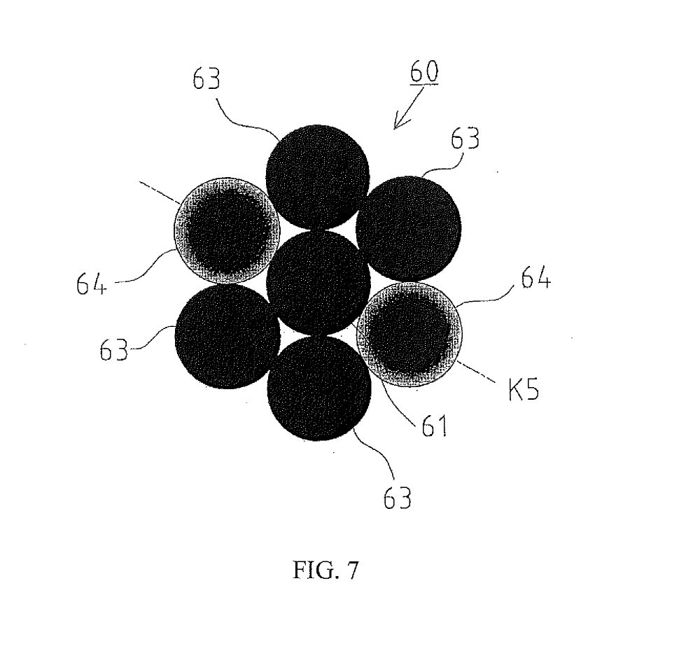

In FIG. 6 described above, the second side element wires 54 (the wires with relatively small tensile strength) are arranged only on one side of the virtual straight line K1 passing through the center of the core element wire 51 in the vertical direction. That is, the second side element wires 54 are asymmetrically located in a circumferential direction of the stranded wire. Whereas, in a stranded wire 60 shown in FIG. 7, second side element wires 64 are arranged point-symmetrically around a core element wire 61.

In the stranded wire 60, the second side element wires 64 are the only pair of side element wires positioned along a virtual straight line K5 passing through the center of the core element wire 61, and all the side element wires other than these second side element wires 64 are first side element wires 63. Materials forming the core element wire 61, the first side element wires 63, and the second side element wires 64 may be the same as described above. That is, the tensile strength of the second side element wires 64 may be smaller compared to that of the core element wire 61 and the first side element wires 63. Accordingly, sufficient torsional strength is ensured for the stranded wire 60 even where a large torque is applied to the stranded wire 60 and the stranded wire has become greatly twisted. Safety is therefore ensured for the stranded wire 60 without deformation or breakage.

Furthermore, where the second side element wires 64 with relatively small tensile strength are point-symmetrically arranged, the torsional stress caused when the stranded wire 60 is greatly twisted is relieved evenly in a circumferential direction via the second side element wire 64. As a result, deformation or breakage of the stranded wire 60 is effectively suppressed, so that sufficient safety is ensured for the stranded wire 60.

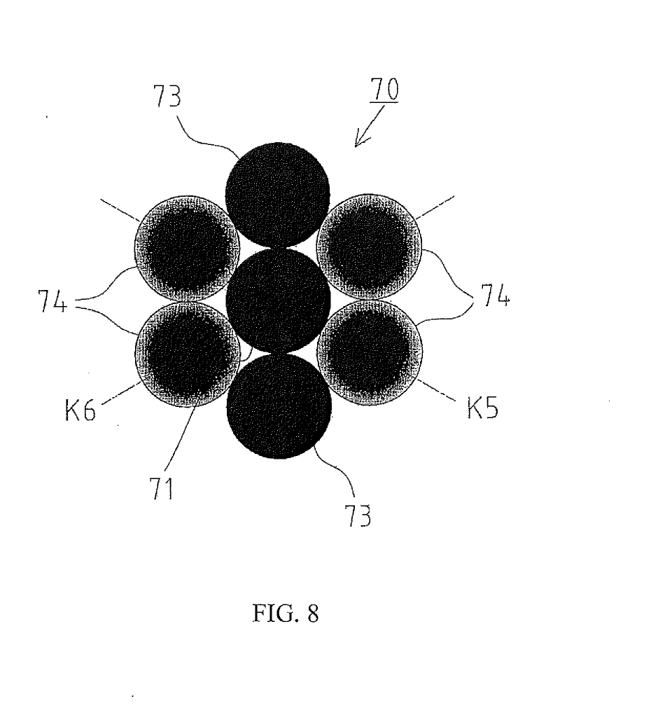

In the stranded wire shown in FIG. 7, the second side element wires 64 are the only pair o I side element wires along the virtual straight line K5 passing through the center of the core element wire. Whereas, in a stranded wire 70 of FIG. 8, second side element wires 74 are positioned not only along the virtual straight line K5, but also along a virtual straight line K6 passing through the center of a core element wire 71. That is, in the stranded wire 70, all the side element wires excluding first side element wires 73 are the second side element wires 74. Materials forming the core element wire 71, the first side element wires 73, and the second side element wires 74 may be the same as those described above. That is, the tensile strength of the second side element wires 74 may be smaller compared to that of the core element wire 71 and the first side element wires 73.

Accordingly, the torsional strength of the stranded wire 70 is enhanced, and a plurality of the second side element wires 74 cause the torsional stress in a circumferential direction to be sufficiently relieved. As a result, it is possible to suppress deformation or breakage of the stranded wire 70 more effectively, thereby ensuring sufficient safety for the stranded wire 70.

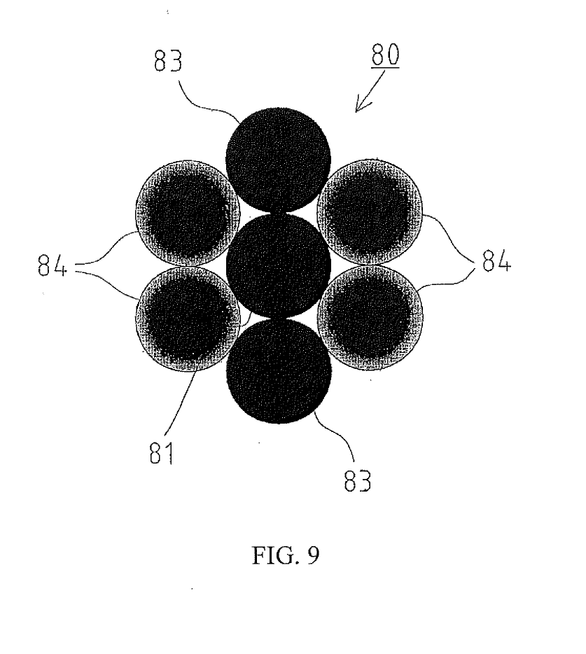

In the stranded wire shown in FIG. 8, the second side element wires may be formed of a radiolucent material, such as stainless steel. Whereas, in a stranded wire 80 of FIG. 9, second side element wires 84 are formed of a radiopaque material. That is, in the stranded wire 80, two pairs of the second side element wires 84 arranged point-symmetrically around a core element wire 81 are formed of a radiopaque material.

Materials forming the second side element wires 84 include, for example, gold, platinum, tungsten, an alloy containing these elements (for example, a platinum-nickel alloy), or the like. It is preferable to employ a platinum-nickel alloy in terms of ensuring a tensile strength smaller than that of both the core element wire 81 and a first side element wires 83.

In this way, the second side element wires 84, which are arranged point-symmetrically around the core element wire 81, are formed of the radiopaque material. Accordingly, since the second side element wires 84 formed of the radiopaque material are evenly arranged in a circumferential direction of the stranded wire 80, it is possible to sufficiently ensure visibility in a radiolucent image even while the stranded wire 80 is being rotated.

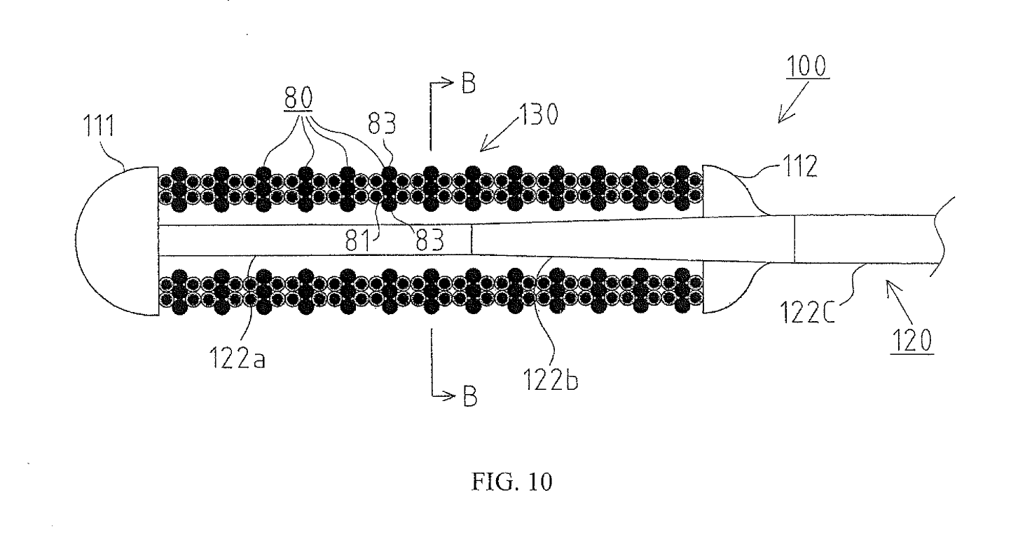

FIG. 10 is an enlarged cross-sectional view showing a part of a guidewire employing a stranded wire of the disclosed embodiments. In FIG. 10, a distal end of the guidewire to be inserted into a body is provided on the left, and a proximal end of the guidewire to be operated by a manipulator, such as a doctor, is provided on the right. FIG. 10 shows a guidewire employing a coiled body composed of the stranded wire shown in FIG. 9. The guidewire including a cross-sectional shape of the coiled body formed of the stranded wire is schematically illustrated at a dimensional ratio different from the actual one.

The guidewire 100 shown in FIG. 10 is used for treatment of the lower extremity vasculature by, for example, the Cross-Over method. The guidewire 100 includes a core shaft 120, and a coiled body 130 covering a circumference of a distal portion of the core shaft 120.

First, description will be given for the core shaft 120. The core shaft 120 includes a small diameter portion 122a, a tapered portion 122b, and a large diameter portion 122c in order from the distal end to the proximal end. The small diameter portion 122a is positioned at the distal end of the core shaft 120 and is the most flexible part of the core shaft 120. The small diameter portion 122a is formed in a tabular shape by press working. The tapered portion 122b has a cross section formed in a tapered round shape whose diameter is gradually reduced toward the distal end. The large diameter portion 122c has a diameter larger than that of the small diameter portion 122a.

The core shaft 120 is formed using materials such as, for example, stainless steel (SUS304), a super elastic alloy such as an Ni—Ti alloy, a piano wire, and a cobalt-based alloy. However, the materials are not especially limited thereto.

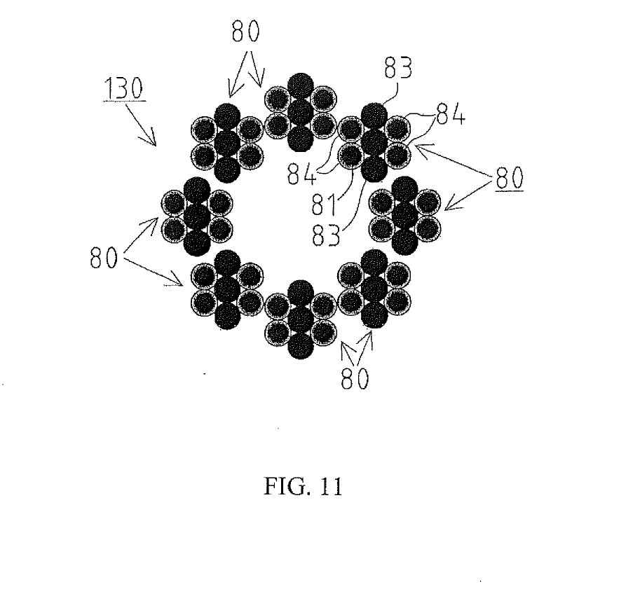

Next, description will be given for the coiled body 130. As shown in FIG. 11, the coiled body 130 is composed of a plurality of the stranded wire 80 shown in FIG. 9 (here, eight stranded wires 80), wound helically.

A distal end of the coiled body 130 is fixed to the distal end of the core shaft 120 with a distal joint portion 111. On the other hand, a proximal end of the coiled body 130 is fixed to the core shaft 120 with a proximal joint portion 112. Materials forming the distal joint portion 111 and the proximal joint portion 112 include, for example, a brazing metal such as an Sn—Pb alloy, a Pb—Ag alloy, an Sn—Ag alloy, and an Au—Sn alloy.

When pushing ahead with the guidewire 100 along an inverted U-shaped path from the lower extremity vasculature of the right leg to the lower extremity vasculature of the left leg by, for example, the Cross-Over method, a large torque is applied to the coiled body 130, and the coiled body 130 may therefore become greatly twisted.

In the guidewire 100, the stranded wire 80 forming the coiled body 130 has the element wires 81, 83, and 83 with relatively great tensile strength arranged linearly in a cross-sectional view, and the torsional strength of the stranded wire 80 is thus enhanced. As a result, even in a case where a large torque is applied to the coiled body 130 and the coil body 130 becomes greatly twisted, safety is ensured without deformation or breakage of the coil body 130. Therefore, it is possible to use the guidewire 100 continuously.

Further, the tensile strength of some of the side element wires (the second side element wires 84) is relatively low. Generally, such a stranded wire has, when greatly twisted, a torsional stress in a circumferential direction, or compressive stress caused by an outside element wire pressing an inside element wire, so that the stranded wire may be deformed or broken.

However, in the guidewire 100, since element wires with relatively low tensile strength (the second side element wires 84) are employed for some of the side element wires, the above-described torsional stress is relieved, and the inward pressing force is reduced. As a result, deformation or breakage of the coiled body 130 is suppressed, and also in this respect, safety is ensured for the coiled body 130.

Additionally, the second side element wires 84 arranged point-symmetrically around the core element wire 81, respectively, are formed of the radiopaque material. Thereby, since the second side element wires 84 formed of the radiopaque material are evenly arranged in a circumferential direction of the stranded wire 80, it is possible to ensure sufficient visibility in a radiolucent image even while the guidewire 100 is inserted deep into a blood vessel and is being rotated.

The guidewire employing the stranded wire of FIG. 9 has been described. However, the guidewire may employ any of the above-described stranded wires. It is therefore possible to suppress deformation or breakage of a coiled body as with the disclosed embodiments, thereby making it possible to ensure safety and allowing continuous use.

What is claimed is:

1. A stranded wire comprising:
a core element wire; and
side element wires wound so as to cover a circumference of the core element wire, wherein the side element wires are stranded together with the core element wire and include at least:
a pair of first side element wires arranged point-symmetrically around the core element wire, and
a second side element wire having a tensile strength lower than a tensile strength of the core element wire and lower than a tensile strength of the first side element wires.

2. The stranded wire according to claim 1, wherein the core element wire and the first side element wires are formed of a same material.

3. The stranded wire according to claim 1, comprising a plurality of the second side element wires arranged point-symmetrically around the core element wire.

4. The stranded wire according to claim 2, comprising a plurality of the second side element wires arranged point-symmetrically around the core element wire.

5. The stranded wire according to claim 3, wherein the second side element wires are formed of a radiopaque material.

6. The stranded wire according to claim 4, wherein the second side element wires are formed of a radiopaque material.

7. The stranded wire according to claim 1, wherein:
the side element wires include a plurality of the second side element wires and a plurality of third side element wires that have a tensile strength greater than the tensile strength of the second side element wires, and
the second side element wires are positioned on a first side of a virtual straight line that passes through the center of the core element wire and the pair of the first side element wires, and the third side element wires are positioned on a second side of the virtual straight line.

8. The stranded wire according to claim 1, comprising a plurality of the core element wires, the pair of first side element wires being arranged point-symmetrically around the plurality of the core element wires.

9. The stranded wire according to claim 1, wherein the side element wires include two pairs of the first side element wires arranged point-symmetrically around the core element wire.

10. A guidewire comprising:
a core shaft; and
a coiled body covering a distal portion of the core shaft and being composed of a plurality of stranded wires wound helically,
wherein each of the stranded wires is composed of:
a core element wire, and
side element wires wound so as to cover a circumference of the core element wire, the side element wires being stranded together with the core element wire and including at least:
a pair of first side element wires arranged point-symmetrically around the core element wire, and
a second side element wire having a tensile strength lower than a tensile strength of the core element wire and a tensile strength of the first side element wires.

11. The guidewire according to claim 10, wherein the core element wire and the first side element wires are formed of a same material.

12. The guidewire according to claim 10, comprising a plurality of the second side element wires arranged point-symmetrically around the core element wire.

13. The guidewire according to claim 11, comprising a plurality of the second side element wires arranged point-symmetrically around the core element wire.

14. The guidewire according to claim 12, wherein the second side element wires are formed of a radiopaque material.

15. The guidewire according to claim 13, wherein the second side element wires are formed of a radiopaque material.

16. The guidewire according to claim 10, wherein:
the side element wires include a plurality of the second side element wires and a plurality of third side element wires having a tensile strength greater than the tensile strength of the second side wires, and
the second side element wires are positioned on a first side of a virtual straight line that passes through the center of the core element wire and the pair of the first side element wires, and the third side element wires are positioned on a second side of the virtual straight line.

17. The stranded wire according to claim 10, comprising a plurality of the core element wires, the pair of the first side element wires being arranged point-symmetrically around the plurality of the core element wires.

18. The stranded wire according to claim 10, wherein the side element wires include two pairs of the first side element wires arranged point-symmetrically around the core element wire.
